(19) United States
(12) Patent Application Publication
(10) Pub. No.: US 2011/0247880 A1
(43) Pub. Date: Oct. 13, 2011

(54) ALIGNMENT ASSEMBLY, DRILLING SYSTEMS AND METHODS

(75) Inventors: Stefan Wrede, Kirchhundem (DE); Thorsten Upmeier, Schlitz (DE); Christof Kruse, Wenden (DE)

(73) Assignee: LONGYEAR TM, INC., South Jordan, UT (US)

(21) Appl. No.: 12/757,760

(22) Filed: Apr. 9, 2010

(51) Int. Cl. E21B 19/14; B25J 15/00; E21B 19/00; B66C 1/44

(52) U.S. Cl. 175/85; 294/106; 414/22.65

(57) ABSTRACT

An alignment assembly includes a shaft, a first gripper coupled to the shaft, and a second gripper coupled to the shaft. The first gripper includes a fixed gripper body and a first rotating gripper body rotatingly coupled to the fixed gripper body. The second gripper may include a second rotating gripper body and a third rotating gripper body. An axis pivot rotatingly couples the second rotating gripper body and the third rotating gripper body.

### BACKGROUND OF THE INVENTION

1. The Field of the Invention

The present invention relates to assemblies, systems and methods for aligning threaded members relative to a drilling system.

2. The Relevant Technology

Drilling rigs are often used for drilling holes into various substrates. Such drill rigs often include one or more drill head mounted to a mast. The rig often includes mechanisms and devices that are capable of moving the drill head along at least a portion of the mast. The drill head often further includes mechanisms that receive and engage the upper end of a threaded member, such as a drill rod or a drill rod and casing system. The drill rod drill rod or drill rod and casing system may be used alone or may be part of a drill string that includes a cutting bit or other device on the opposing end, which may be referred to as a bit end.

The drill head applies a force to the drill rod or pipe which is transmitted to the drill string. If the applied force is a rotational force, the drill head may thereby cause the drill string to rotate within the bore hole. The rotation of the drill string may include the corresponding rotation of the cutting bit, which in turn may result in cutting action by the drill bit. The forces applied by the drill head may also include an axial force, which may be transmitted to the drill string to facilitate penetration into the formation. Once an upper end of the drill rod is near the surface of the formation, the drill rod is clamped, the drill head uncoupled from the drill rod, and an additional drill rod is coupled to the drill head. The additional drill rod is then coupled to the clamp drill rod and drilling operations resume.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

An alignment assembly includes a shaft, a first gripper coupled to the shaft, and a second gripper coupled to the shaft. The first gripper includes a fixed gripper body and a first rotating gripper body rotatingly coupled to the fixed gripper body. The second gripper may include a second rotating gripper body and a third rotating gripper body. An axis pivot rotatingly couples the second rotating gripper body and the third rotating gripper body.

This Summary is provided to introduce concepts in a simplified form that are further described below in the Detailed Description. This Summary is not intended to identify key features or essential characteristics of the claimed subject matter, nor is it intended to be used as an aid in determining the scope of the claimed subject matter.

### BRIEF DESCRIPTION OF THE DRAWINGS

To further clarify the above, a more particular description of the disclosure will be rendered by reference to specific examples that are illustrated in the appended drawings. It is appreciated that these drawings depict only typical examples and are therefore not to be considered limiting. The examples will be described and explained with additional specificity and detail through the use of the accompanying drawings in which:

FIG. 1 illustrates a drilling system having an alignment assembly according to one example;

FIG. 2A illustrates an elevation view of an alignment assembly coupled to a mast according to one example;

FIG. 2B illustrates a perspective view of the alignment assembly of FIG. 2A;

FIG. 3A illustrates an exploded view of a first gripper according to one example;

FIG. 3B illustrates a top plan view of the first gripper of FIG. 3A in an open state;

FIG. 3C illustrates a top plan view of the first gripper of FIG. 3B in a closed state;

FIG. 4A illustrates an exploded view of a second gripper according to one example;

FIG. 4B illustrates a top plan view of the second gripper of FIG. 4A in an open state;

FIG. 4C illustrates a top plan view of the first gripper of FIG. 4B in a closed state;

FIG. 5 illustrates a perspective view of a support assembly according to one example; and

FIGS. 6A-6C illustrate a process for aligning and coupling threaded members to drill heads according to one example.

Together with the following description, the figures demonstrate non-limiting features of exemplary devices and methods. The thickness and configuration of components can be exaggerated in the figures for clarity. The same reference numerals in different drawings represent similar, though not necessarily identical, elements.

### DETAILED DESCRIPTION OF THE PREFERRED EMBODIMENTS

Assemblies, systems, and methods are provided herein for aligning and coupling threaded members, such as casing, drill rods, and the like to a drill system. In at least one example, an alignment assembly includes a first gripper and a second gripper. In one exemplary process the alignment assembly facilitates coupling of a plurality of threaded members to a plurality of connectors associated with at least one drill head. More specifically, the first gripper may simultaneously orient and engage a casing. In particular, the first gripper includes a fixed gripper body and a rotating gripper body. The rotating gripper body is rotatingly coupled to the fixed gripper body so as to allow the rotating gripper body to rotate relative to the fixed gripper. As the rotating gripper body rotates, the rotating gripper body moves the casing into engagement with the fixed gripper body. Since the position of the fixed gripper body is known, moving the casing into engagement with the fixed gripper body can move the casing to a known position and orientation.

Thereafter, a drill rod within the casing is moved relative to the casing and then engaged by the second gripper. An inner connector of a rotary head then couples to the drill rod. With the drill rod then coupled to the inner connector, the second gripper can be disengaged from the drill rod. At that point, the casing may not yet be coupled to the outer connector of the rotary head. By virtue of the fact that the drill rod is within the casing, the casing is larger than the drill head and thus it may be desirable for the outer connector to have a larger diameter than the inner connector. The second gripper may be configured to open sufficiently to allow the second, larger connector to pass therethrough. As a result, the second connector can be moved into engagement with the casing while leaving the alignment assembly in place since the second connector can pass through the second gripper. Once the second drill head is coupled to the casing, the first gripper can be disengaged and the casing and drill rod can then be threaded to additional drill rods or casing as desired. Such a configuration can allow for rapid alignment and coupling of threaded members to a drilling system, which can improve the efficiency of a drilling operation.

Though casings and drill rods are described at various locations hereinafter, it will be appreciated that the alignment assembly may be suitable for use with any type of threaded members. Further, various positions, orientations, configurations, and/or dimensions may be exaggerated for clarity. The drawings are not necessarily to scale.

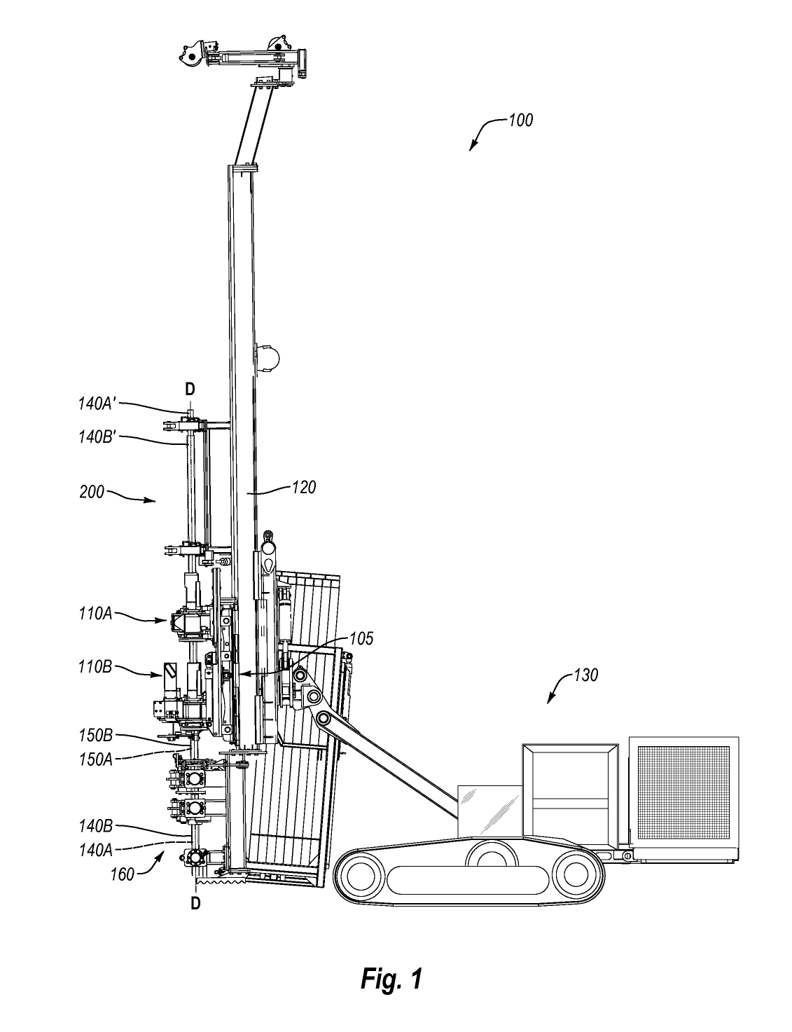

FIG. 1 illustrates a drilling system 100 that includes a sled assembly 105 and drill heads 110A, 110B coupled to the sled assembly. The sled assembly 105 can be coupled to a mast 120 that in turn is coupled to a drill rig 130. The drill heads 110A, 110B are configured to have one or more threaded member(s) coupled thereto. The threaded members may include an inner threaded member 140A and an outer threaded member 140B that are coupled to the drills heads 110A, 110B by inner and outer connectors 150A, 150B respectively.

In the illustrated example, the inner threaded member 140A may be positioned within the outer threaded member 140B. As a result, the inner threaded member 140A may have an outer diameter that is smaller than the inner diameter of the outer threaded member 140B. Similarly, the inner connector 150A may be smaller than the outer connector 150B since the inner connector 150A extends through the outer connector 150B. In at least one example, the outer connector 150B has an outer diameter that is as large as or larger than a thread diameter of the outer threaded member 140B. The thread diameter may be an internal thread or an external thread diameter. Such a configuration allows the drill heads 110A, 110B to simultaneously drive the inner and outer threaded members 140A, 140B. While two drill heads are shown, it will be appreciated that the alignment assembly 200 described herein may be used with a single drill head, including a single rotary head driving a single threaded member as well as a single rotary head coupled to two threaded members with a double tube connector.

Threaded members can include, without limitation, drill rods and rod casings. The threaded members 140A, 140B can in turn be coupled to additional threaded members 140A′, 140B′ to form drill strings. The drill strings can also be coupled to drill bits or other down-hole tools configured to interface with the material to be drilled, such as a formation.

In at least one example, the drill heads 110A, 110B are configured to rotate the threaded members 140A, 140B during a drilling process. In particular, the drill heads 110A, 110B may vary the speed and/or the direction of rotation of the threaded members 140A, 140B as desired according to the drilling process.

Further, the sled assembly 105 can be configured to translate relative to the mast 120 to apply an axial force to the drill heads 110A, 110B to urge a distal end of a drill string, of which the threaded members 140A, 140B are part, into a formation during a drilling process. In particular, the drill heads 110A, 110B may translate parallel to a drilling axis D-D. As the threaded members 140A, 140B reach a foot of the mast 120, the additional threaded members 140A′, 140B′ may be added to allow deeper penetration into a formation.

In particular, as the drill heads 110A, 110B approaches the bottom of the mast 120, a clamping/breakout assembly 160, which is also positioned near the bottom of the mast 120, is actuated to clamp the inner and outer threaded members 140A, 140B. The drill heads 150A, 150B can then rotate connectors 150A, 150B out of engagement with the threaded members 140A, 140B

Once the threaded members 140A, 140B have been decoupled from the connectors 150A, 150B, additional threaded members 140A′, 140B′ may be coupled to the connectors 150A, 150B. In the illustrated example, an alignment assembly 200 is coupled to or integrated with the mast 120. As will be discussed in more detail below, the alignment assembly 200 may be configured to have the additional threaded members 140A′, 140B′ positioned thereon and moved to a desired orientation while the threaded members 140A, 140B are being moved into a formation by the drill heads 110A, 110B as described above.

After the threaded members 140A, 140B are decoupled from the connectors 150A, 150B, the alignment assembly 200 may then move the threaded members 140A, 140B into position below the drill heads 110A, 110B. The drill heads 110A, 110B can rotate the connectors 150A, 150B into engagement with the additional threaded members 140A′, 140B′. Such a configuration can allow for the rapid addition of threaded members during a drilling process.

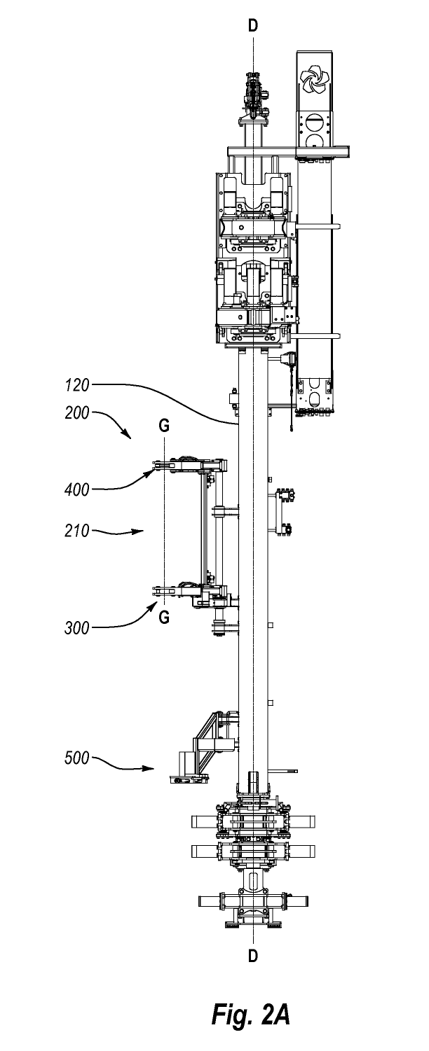

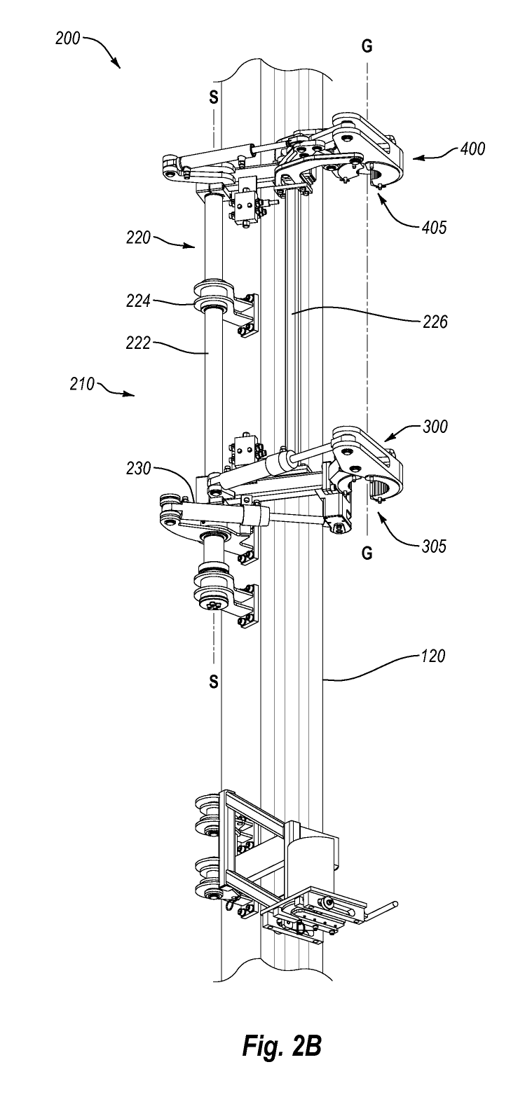

FIG. 2A illustrates the alignment assembly 200 in more detail. As illustrated in FIG. 2A, the alignment assembly 200 may include a gripper assembly 210 having a first gripper 300 and a second gripper 400. In the illustrated example, the first gripper 300 is positioned beneath the second gripper 400. However, it will be appreciated that the first gripper 300 may be positioned above the second gripper 400 as desired. Both the first gripper 300 and the second gripper 400 may be positioned above a support assembly 500. For ease of reference, a gripping axis G-G may be described which passes through openings associated with the first gripper assembly 300 and the second gripper assembly 400. As will be discussed in more detail below, the alignment assembly 200 may be configured to move between an offset state, which is shown in FIG. 2A, to an aligned state.

When the alignment assembly 200 is an offset state, the gripping axis G-G may be generally parallel to, but offset from, the drilling axis D-D. In an aligned state, the gripping axis G-G may be aligned to the drilling axis D-D both with respect to position and orientation. As will be discussed in more detail below, the alignment assembly 200 may be configured to align additional threaded members to the gripping axis G-G while in the offset state. As a result, when the alignment assembly 200 is moved to the aligned state in which the gripping axis G-G is aligned with the drilling axis D-D, the threaded members are also aligned with the drilling axis D-D.

As shown in FIGS. 1 and 2A, additional threaded members 140A′ 140B′ may be positioned on and oriented by the alignment assembly 200, which is in the offset state, while the drilling system 100 is in the process of actively placing threaded members 140A, 140B. Once the other threaded members 140A, 140B have been placed and the connectors 150A, 150B have been decoupled from the threaded members 140A, 140B, the additional threaded members 140A′, 140B′ may be rapidly coupled to the connectors 150A, 150B by positioning the gripping axis G-G on the drilling axis D-D. In at least one example, this may be accomplished with a single movement. With the additional threaded members 140A′, 140B′ thus positioned, the connectors 150A, 150B may be coupled to the additional threaded members 140A′, 140B′ shortly after placing the threaded members 140A, 140B. Such a configuration can reduce the time associated with adding threaded members 140A′, 140B′ to a drill string, which can increase the efficiency and safety of a drilling process.

FIG. 2B is a perspective view of the alignment assembly 200 in more detail. As illustrated in FIG. 2B, the gripper assembly 210 may be coupled to the mast 120 by way of a frame assembly 220 and a positioning mechanism, such as a swing cylinder 230. In the illustrated example, the swing cylinder 230 is configured to exert a force against the frame assembly 220 to move the gripper assembly 210 between the offset and aligned states.

In particular, the frame assembly 220 generally includes a shaft 222 mounted to the mast 120 by way of mounting brackets, collectively labeled as 224. The mounting brackets 224 may include grooves defined therein to cooperate with a feather key to thereby couple the brackets 224 to the shaft 222. In the illustrated example, the shaft 222 defines a shaft axis S-S that is generally parallel to the drilling axis D-D (FIG. 2A) and the gripping axis G-G. The first gripper 300 and the second gripper 400 are each coupled to the shaft 222 so as to allow the first gripper 300 and the second gripper 400 to rotate about the shaft axis S-S.

In at least one example, the swing cylinder 230 is coupled to the mast 120 and the first gripper 300 to allow the swing cylinder 230 to exert a force on the first gripper 300 to cause the first gripper 300 to rotate about the shaft axis S-S. The frame assembly 220 may further include a reinforcement bar 226 that extends between the first gripper 300 and the second gripper 400. The reinforcement bar 226 may couple the first gripper 300 and the second gripper 400 in such a manner that rotation of the first gripper 300 results in a similar rotation of the second gripper 400. The reinforcement bar 226 may also maintain an alignment of the first gripper 300 and the second gripper 400, which may help maintain the alignment of the gripping axis G-G to the shaft axis S-S.

The gripping axis G-G may be defined between any desired reference points associated with the first gripper 300 and the second gripper 400. For ease of reference, the gripping axis G-G will be described with reference to centers of first and second gripper openings 305, 405 as shown, which each may be described as an opening configured to receive threaded members therein while the first gripper 300 and the second gripper 400 are in desired states, such as closed states. The exemplary configuration and operation of the example first gripper 300 will now be described in more detail.

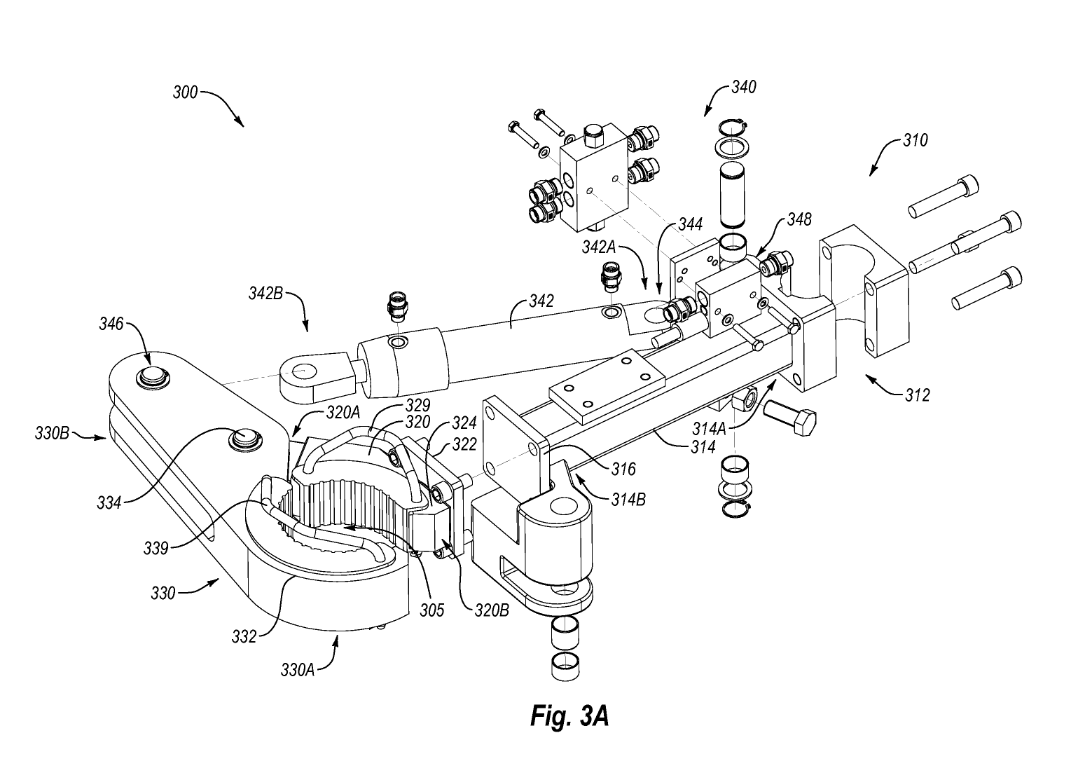

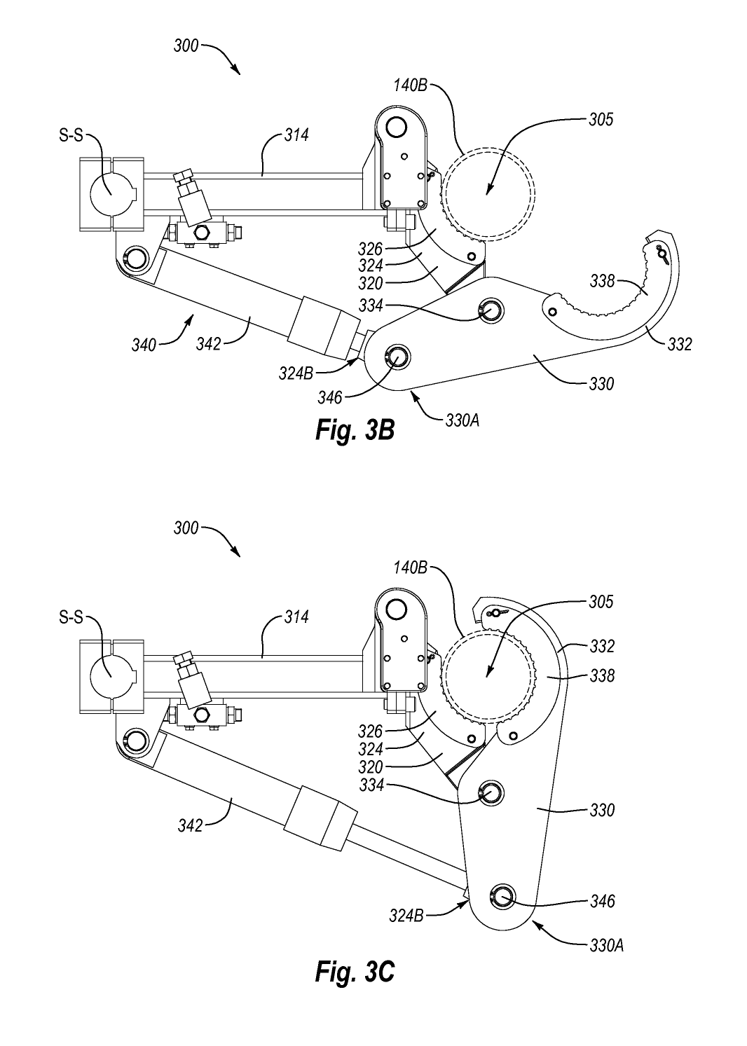

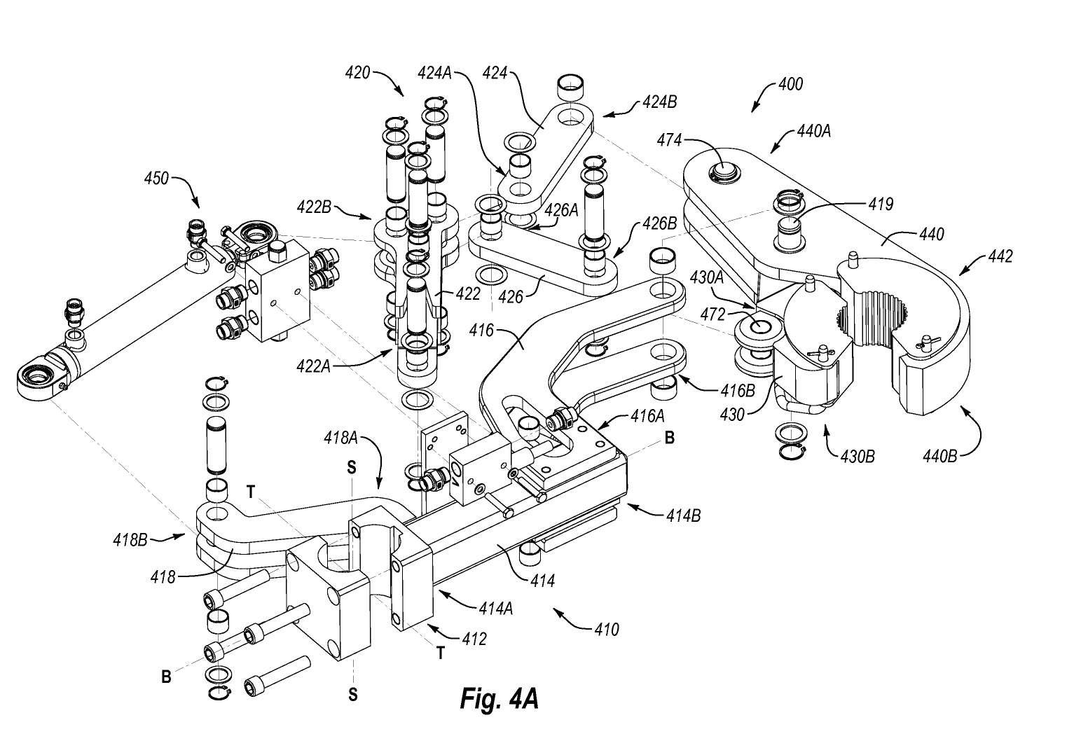

FIG. 3A illustrates the first gripper 300 in more detail. As illustrated in FIG. 3A, the first gripper 300 generally includes a first mounting assembly 310, a fixed gripper body 320, a rotating gripper body 330, and an actuating mechanism 340. Various fasteners, pins, and other coupling components are shown. For ease of reference, these coupling components will not be described to focus on the function of the first gripper 300.

In the illustrated example, the first mounting assembly 310 generally includes a shaft bracket 312, a base arm 314, and a gripper bracket 316. The shaft bracket 312 is configured to be mounted to the shaft 222 of the frame assembly 220 (both seen in FIG. 2B). The base arm 314 includes a first end 314A coupled to the shaft bracket 312 and a second end 314B coupled to the gripper bracket 316. The gripper bracket 316 may be configured to have the example fixed gripper body 320 mounted thereto.

In particular, the fixed gripper body 320 may include a mounting bracket 322 and a jaw portion 324, both of which may be positioned between a first end 320A and a second end 320B of the fixed gripper body 320. The example mounting bracket 322 is positioned on one side of the fixed gripper body 320 while the jaw portion 324 is positioned on an opposing side of the fixed gripper body 320.

The mounting bracket 322 may be secured to the gripper bracket 316 in such a manner as to fix the position of the fixed gripper body 320 with respect to the first mounting assembly 310. As a result, the position of the jaw portion 324 may also be fixed relative to the first mounting assembly 310.

In the illustrated example, a jaw portion 332 is positioned between a first end 330A and a second end 330B of the rotating gripper body 330. The jaw portion 332 may be positioned to face the jaw portion 324 of the fixed gripper body 320 to thereby define the first gripper opening 305. Consequently, controlling the position of the jaw portion 332 relative to the jaw portion 324 may control the size of the first gripper opening 305. In at least one example, the position of the jaw portion 332 may be controlled by rotating the rotating gripper body 330 relative to fixed gripper body 320.

As shown in FIG. 3A, a body pivot 334 rotatingly couples the fixed gripper body 320 and the rotating gripper body 330. Such a configuration allows the rotating gripper body 330 to rotate relative to the fixed gripper body 320 since the position of the fixed gripper body 320 is fixed. The rotation of the rotating gripper body 330 relative to the fixed gripper body 320 may be controlled by actuating mechanism 340.

The actuating mechanism 340 includes a piston 342. A first end 342A of the piston 342 is rotatingly coupled to first actuator pivot 344 mounted to the base arm 314 while a second end 342B of the piston 342 is coupled to a second actuator pivot 346 positioned between the body pivot 334 and the second end 330B of the rotating gripper body 330. The piston 342 is controlled by sequence valving 348, which causes the piston 342 to extend and retract as desired.

Referring to both FIGS. 3B and 3C, as the piston 342 extends from the retracted position shown in FIG. 3B to the extended position shown in FIG. 3C, the second end 342B of the piston 342 acts against the first end 330A of the rotating gripper body 330 to cause the rotating gripper body 330 to rotate about the body pivot 334. As the piston 342 causes the rotating gripper body 330 to rotate relative to the pivot body 334, the jaw portion 332 moves relative to the jaw portion 324, thereby changing the size of the first gripper opening 305. As a result, the first gripper 300 moves between the open state shown in FIG. 3B and the closed state shown in FIG. 3C.

As shown in FIGS. 3B and 3C, the lower gripping opening 305 is defined between the fixed gripper body 320 and the rotating gripper body 330. The size of the first gripper opening 305 in the closed state may depend on the configuration of removable inserts coupled to the fixed gripper body 320 and the rotating gripper body 330. In particular, a first removable insert 326 may be coupled to the fixed gripper body 320 by a pin 329 (FIG. 3A) while a second removable insert 338 may be coupled to the rotating gripper body 330 by a pin 339 (FIG. 3A). In such an example, the size of the lower gripping opening 305 may be selected by selecting the thickness and/or shape of the removable inserts 326, 338. By selecting appropriate thicknesses and/or shapes for the removable inserts 326, 338, the first gripper 300 can be configured to engage threaded members of different diameters or shapes while maintaining a center of the lower gripping opening 305 at a desired position and orientation relative to the shaft axis S-S (FIG. 2B). Further, in the illustrated example the pins 329, 339 may be double pins (both seen in FIG. 3A).

Surfaces on the removable insert 326 that interface with the threaded member 140B (shown in dashed lines) may be configured to move the threaded member 140B to an orientation that is generally parallel to the shaft axis S-S. In at least one example, the surfaces on the removable insert 326 may be generally parallel with the shaft axis S-S when the removable insert 326 is secured to the jaw portion 324 of the fixed gripper body 320. In such a configuration, as the first gripper 300 moves to the closed state, the threaded member 140B is simultaneously moved into engagement with the removable insert 326.

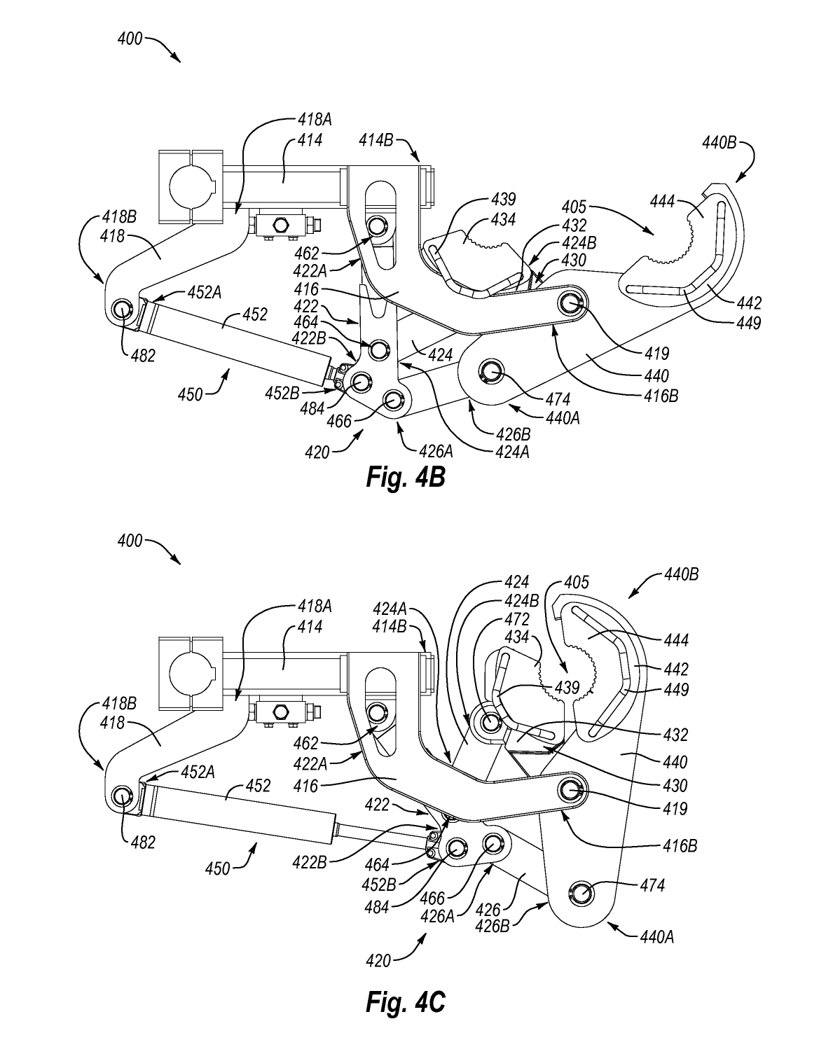

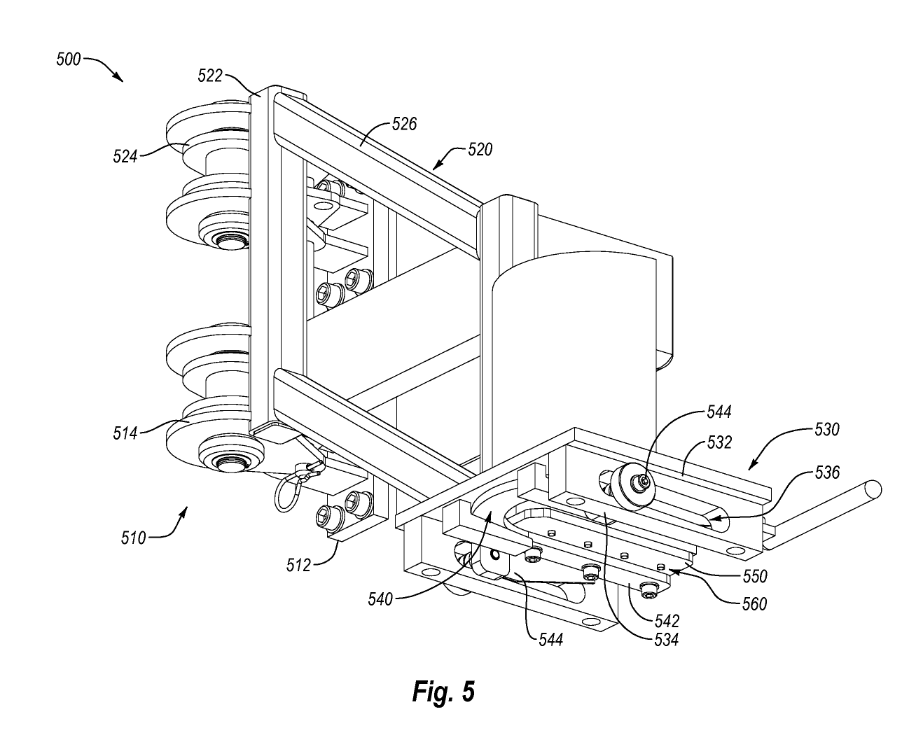

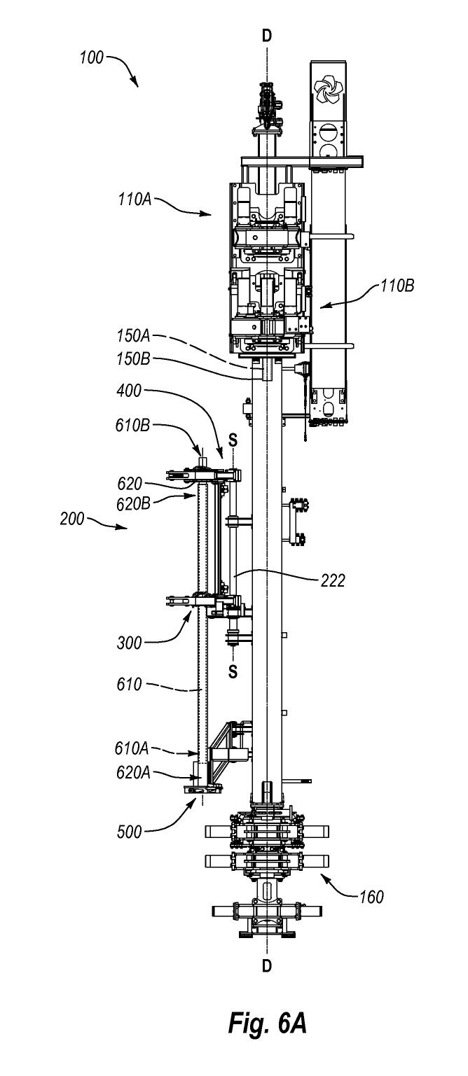

The position and orientation of the removable insert 326 are relatively fixed since the removable insert 326 is mounted to the first rotating gripper body 300, which is at a fixed position relative to the base arm 314. As a result, as the threaded member 140B is moved into contact with the removable insert 326, the threaded member 140B is moved into alignment with the surfaces on the removable insert 326 that engage the threaded member 140B. Since these surfaces are oriented parallel to the shaft axis S-S, the threaded member 140B is also oriented parallel to the shaft axis S-S. Accordingly, the first gripper 300 may be configured to simultaneous grip and align a threaded member 140B, such as a casing or other outer threaded member. Gripping an outer threaded member 140B (FIG. 1) may allow the alignment assembly (FIG. 1) to maintain the outer threaded member 140B in a desired position to facilitate relative movement of the inner threaded member 140A (FIG. 1) to position the inner threaded member 140A for gripping by the second gripper 400 (FIG. 4A).

As shown in FIG. 4A, the second gripper 400 includes an second mounting assembly 410, a linkage assembly 420, a first rotating gripper body 430, a second rotating gripper body 440, and an actuating mechanism 450. In the illustrated example, the second mounting assembly 410 generally includes a shaft bracket 412, a base arm 414, a first base extension 416, and a second base extension 418. The shaft bracket 412 may be mounted to the shaft 222 of the frame assembly 220 (FIG. 2B). A first end 414A of the base arm 414 is coupled to the shaft bracket 412 and a second end 414B of the base arm 414 extends away therefrom.

The base arm 414 defines a base axis B-B that is transverse to and passes through the shaft axis S-S. A transverse axis T-T may also be referenced that is transverse to both the base axis B-B and the shaft axis S-S while also passing through both the shaft axis S-S and the base axis B-B. The discussion of the various axes is for ease of reference only and should not be construed as limiting.

The example first base extension 416 may be coupled to the second end 414B of the base arm 414. In particular, a first end 416A of the first base extension 416 may couple to the base arm 414 adjacent the second end 414B so as to minimize movement of the first base extension 416 relative to the base arm 414. In at least one example, a second end 416B of the first base extension 416 is offset from the base axis B-B.

The example second base extension 418 is coupled to or integrated with a first end 414A of the base arm 414 so as to minimize movement of the second base extension 418 relative to the base arm 414. In particular, a first end 418A of the second base extension 418 may be coupled to the base arm 414 while a second end 418B of the first base extension 418 extends away from the base arm 414. In at least one example, the second end 418B of the first base extension 418 is offset from the base axis B-B. More specifically, the second end 418B of the second base extension 418 may be positioned on the same side of the base axis B-B as the second end 416B of the first base extension 416. Further, the second end 418B of the second base extension 418 may be positioned on one side of the transverse axis T-T while the first end 418A is positioned on an opposing side of the transverse axis T-T.

As will be discussed in more detail below, the linkage assembly 420 is coupled to the second mounting assembly 410 in such a manner that operation of the actuating mechanism 450 moves the second gripper 400 between the open state shown in FIG. 4B and the closed state shown in FIG. 4C. As shown in FIGS. 4B-4C, the size of the gripper opening 405 in the open state is larger than the size of the second gripper opening 405 in the close state. In at least one example, when in the open state, the second gripper opening 405 has a diameter of about 270 mm, which may be about five times or more than the diameter of the second gripper opening 405 in the closed state. Such a configuration can allow the upper gripper 400 to allow a tubular interface with a diameter of between about 30 mm and about 260 mm to pass therethrough while in the open state while still allowing the upper gripper 400 to engage threaded members with diameters of between about 30 mm and about 133 mm while in the closed state.

Referring again to FIG. 4A, the linkage assembly 420 generally includes a first link member 422, a second link member 424, and a third link member 426. The first, second, and third link member 422, 424, 426 each include a first end 422A, 424A, 426A and a second end 422B, 424B, 426B respectively. As shown in FIGS. 4B and 4C, the first end 422A of the first link member 422 rotatingly couples to the base arm 414 at a first link member pivot 462 positioned near the second end 414B of the base arm 414.

Referring again to FIG. 4A, the linkage assembly 420 generally includes a first link member 422, a second link member 424, and a third link member 426. The first, second, and third link member 422, 424, 426 each include a first end 422A, 424A, 426A and a second end 422B, 424B, 426B respectively. As shown in FIGS. 4B and 4C, the first end 422A of the first link member 422 rotatingly couples to the base arm 414 at a first link member pivot 462 positioned near the second end 414B of the base arm 414.

By way of introduction, movement of the first link member 422 is transferred to the first rotating gripper body 430 by way of the second link member 424. The movement of the first link member 422 is also transferred to the second rotating gripper body 430 by way of the third link member 426. Movement of the first rotating gripper body 430 will now be discussed in more detail.

As shown in FIGS. 4A-4C, the first end 424A of the example second link member 424 rotatingly couples to the first link member 422 at a second link pivot 464 positioned near the second end 422B. The second end 424B of the second link member 424 may rotatingly couple to the first rotating gripper body 430 at a first body pivot 472. In particular, the first rotating gripper body 430 may generally include a first end 430A and a second 430B with a jaw portion 432 formed near the second end 430B. The first body pivot 472 may be located near the jaw portion 432. The first body pivot 472 may allow movement of the first link member 422 to be transferred to the first rotating gripper body 430 through the second link member 424.

More specifically, an axis pivot 419 may rotatingly couple the first base extension 416, the first rotating gripper body 430 and the second rotating gripper body 440. As previously discussed, the first base extension 416 is coupled to the base arm 414 so as to minimize movement of the first base extension 416 relative to the base arm 414. As a result, the first base extension 416 may fix the location of the axis pivot 419.

Since the first rotating gripper body 430 and the second rotating gripper body 440 are coupled by the axis pivot 419, fixing the location of the axis pivot 419 may cause the axis pivot 419 to serve as a center of rotation for both the first rotating gripper body 430 and the second rotating gripper body 440. Consequently, motion of the first link member 422 that is transferred to the first rotating gripper body 430 by the second link member 424 causes the first rotating gripper body 430 to rotate about the axis pivot 419.

As previously introduced, motion of the first link member 422 may be transferred to the second rotating gripper body 440 by the third link member 426 to cause the second rotating gripper body 440 to also rotate about the axis pivot 419. In particular, a first end 426A of the third link member 426 is rotatingly coupled to the first link 422 by way of a third link pivot 466. The second end 426A of the third link member 426 couples to the second rotating gripper body 430 by way of a second body pivot 474. The second body pivot 474 may be positioned near a second end 440B of the second rotating gripper body 440.

In the illustrated example, the axis pivot 419 is positioned between a first end 440A and a second end 440B of the second rotating gripper body 440. As a result, movement of the second end 440B in response to movement of the third link member 426 causes the second rotating gripper body 440 to rotate about the axis pivot 419.

The example second rotating gripper body 440 includes a jaw portion 442 formed near the second end 440B thereof. The jaw portion 442 faces the jaw portion 432 associated with the first rotating gripper body 430 to thereby define the second gripper opening 405. The size of the second gripper opening 405 thus corresponds to the separation between the first rotating gripper body 430 and the second rotating gripper body 440. Consequently, relative movement of the first rotating gripper body 430 and the second rotating gripper body 440 varies the size of the second gripper opening 405.

As introduced, the first rotating gripper body 430 and the second rotating gripper body 440 both rotate about the axis pivot 419. As shown in FIGS. 4B and 4C, movement of the second end 422B of the first link member 422 toward the axis pivot 419 causes the first rotating gripper body 430 and the second rotating gripper body 440 to rotate in such a manner as to move the jaw portion 432 and the jaw portion 442 toward each other. As the jaw portion 432 and the jaw portion 442 move toward each other, the second gripper 442 moves toward the closed state shown in FIG. 4C. Similarly, as the second end 422B of the first link member 422 moves away from the axis pivot 419, the jaw portion 432 and the jaw portion 442 move away from each other to move the second gripper 442 toward the open state shown in FIG. 4B.

The relative position of the second end 422B of the first link member 422 with respect to the axis pivot 419 may be controlled by the actuating mechanism 450. In the illustrated example, the actuating mechanism 450 generally includes a piston 452 that is controlled by sequence valve assembly 454 (FIG. 4A). The piston 452 includes a first end 452A that rotatingly couples to the second end 416B of the first base extension 416 at a first actuator pivot 482. A second end 452B of the piston 452 rotatingly couples to the first link member 422 at a second actuator pivot 484.

As a result, as shown in FIGS. 4B and 4C, retraction and extension of the piston 452 causes the first link member 422 to rotate relative to the base arm 414. Rotation of the first link member 422 allows the second end 422B of the first link member 422 to move relative to the axis pivot 419, which causes the jaw portions 432, 442 to move relative to each other to move the second gripper 400 between the open and closed states.

As previously introduced, the second gripper 400 may be configured to open relatively widely in the open state. Various aspects of the frame assembly 410 (FIG. 4A), the linkage assembly 420, and/or other component may allow for such functionally. For example, as also shown in FIGS. 4B and 4C, the second link member pivot 464, the third link member pivot 466, and the second actuator pivot 484 are positioned near or on the second end 422B of the first link member 422.

In the illustrated example, the second link pivot 464, the third link pivot 466, and the second actuator pivot 484 are positioned and offset relative to each other on the first link member 422. For example, the first link member pivot 462, the second link member pivot 464 and the third link member pivot 466 may be non-collinear. Similarly, the second link member pivot 464, the third link member pivot 466, and the second actuator pivot 484 may also be non-collinear.

In the illustrated example, the various pivots are positioned and offset such that as the piston 452 extends and retracts between the positions shown in FIGS. 4B and 4C, the third link member pivot 466 moves between opposing sides of a line between the second actuator pivot 482 and the second body pivot 474. In particular, when the piston 452 is extended as shown in FIG. 4B the third link pivot 466 is positioned outside of a line between the second actuator pivot 484 and the second body pivot 474. When the piston 452 is refracted as shown in FIG. 4C, the third link pivot 466 is positioned interior to the line between the second actuator pivot 484 and the second body pivot 474. This and/or other aspects of the linkage assembly 420 may allow the linkage assembly 420 to open relatively widely.

In at least one example, a first removable insert 434 is coupled to the first rotating gripper body 430 with a pin 439 while a second removable insert 444 may be coupled to the second rotating gripper body 440 with a pin 449. The size and/or configuration of the first and second removable inserts 434, 444 may be selected to allow the second gripper 400 to engage a desired type of threaded member and may be replaced or swapped as appropriate. In addition, the first rotating gripper body 430 may be configured to open widely to allow a relatively large connector to pass therethrough, which in turn can facilitate an alignment and coupling operation, which will be described in more detail at an appropriate point herein after. Further, in the illustrated example the pins 439, 449 may be double pins.

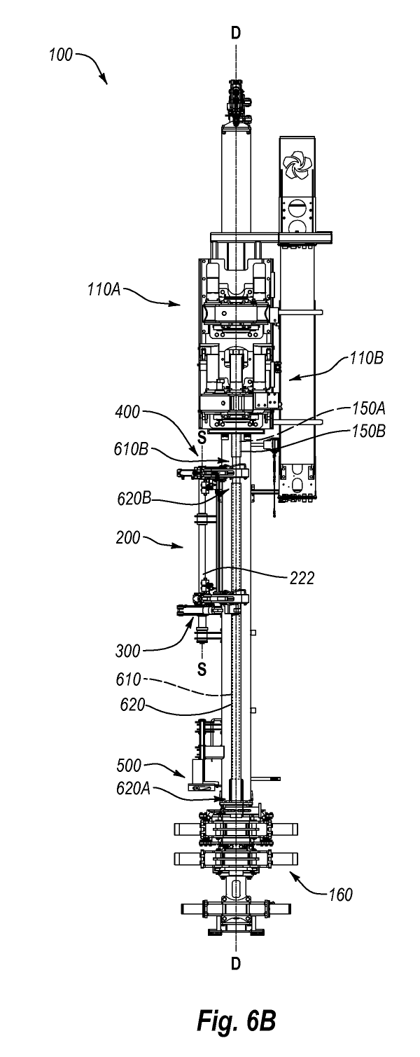

As previously discussed and as shown in FIG. 2A, the alignment assembly 200 also includes a support assembly 500. As illustrated in FIG. 5, the support assembly 500 may generally include a mounting assembly 510, a swing frame 520, a slide frame 530, a slide 540, and a wear member 550.

The mounting assembly 510 may include a plurality of brackets 512 and tabs 514 coupled to the brackets 512. The brackets 512 may be configured to be coupled to the mast 120 (FIG. 2A) while the tabs 514 may be configured to cooperate with the swing frame 520 to allow the swing frame 520 to rotate relative to the mounting assembly 510.

In particular, the swing frame 520 may include a generally vertical member 522 and tabs 524. The tabs 524 may be configured to interact with the tabs 514 to rotatingly couple the swing frame 520 to the mounting assembly 510. The swing frame 520 may further include arms 526 that extend away from the vertical member 522.

The arms 526 may couple to a platform portion 532 of the slide frame 530. Opposing rails 534 may extend from the platform portion 532. In the illustrated example, channels 536 are defined in the rails 534. The channels 536 may be configured to guide and constrain movement of the slide 540 relative to the slide frame 530.

In particular, the slide 540 may generally include a body 542 and guides 544. The guide 544 may be configured to engage the channels 536 to allow the slide 540 to translate relative to the slide frame 534. The wear members 550 may be removably coupled to the body 542 as desired.

The slide frame 530 may be configured to constrain the movement of the slide 540 to translation that is generally transverse to the drill axis D-D (FIG. 1) when the support assembly 500 is coupled to the mast 120 (FIG. 1). As a result, the slide 540 and the wear member 550 may be positioned at a known location along the drilling axis D-D (FIG. 1). Consequently, when threaded members are placed on the wear members 550, the end of the threaded member in contact therewith may be at a known location along the drill axis D-D. Further, a recess 560 may be defined between the slide frame 530, the slide 540 and/or the wear members 550 to allow a lifting member to pass therethrough to allow positioning of threaded members onto and relative to the support assembly 500. Additionally, the translation of the slide 530 may allow a bottom end of a threaded member to move as it moved into alignment by engagement with the first gripper 300 (FIG. 2A), which may be part of a process for aligning and coupling threaded members to a drilling system.

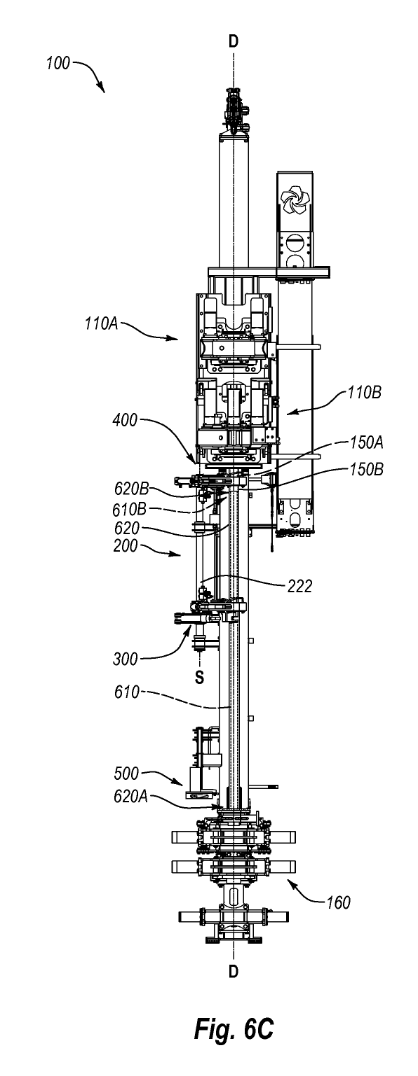

FIGS. 6A-6C illustrate an exemplary process for aligning and coupling threaded members to a drilling system 100. For ease of reference, a drill rod 610 and a casing 620 and will be discussed in the process, though it will be appreciated that the discussion may be applicable to any threaded members. As illustrated in FIG. 6A, the process begins by moving the alignment assembly 200 to the offset state, moving the first gripper 300 to its open state, and moving the second gripper 400 to its open state.

Thereafter, the process continues by placing the casing 620 and the drill rod 610 on the support assembly 500. As previously introduced, placing the casing 620 and the drill rod 610 on the support assembly 500 may initially place first ends 610A, 620A thereof at known positions relative to the drilling axis D-D. This position may be offset from, but movable into alignment with, the drilling axis D-D.

The first gripper 300 may then be actuated to grip the casing 620. As previously introduced, actuation of the first gripper 300 may orient the casing 620 to be generally parallel to the shaft 222 and thus the shaft axis S-S. The shaft axis S-S may be parallel to the drilling axis D-D. As a result, the actuation of the first gripper 300 may move the casing 620 to an orientation that is generally parallel to the drilling axis D-D.

Thereafter, as also shown in FIG. 6A, the drill rod 610 may be lifted relative to the casing 620 such that a second end 610B of the drill rod 610 is above a second end 620B of the casing 620. In at least one example, the casing 620 and the drill rod 610 may be positioned on the support assembly 500 by using a j-hook and winch. Other lifting mechanisms or methods may be utilized as desired. With the drill rod 610 is at a desired position with respect to the casing 620, the second gripper 400 may be actuated to cause the second gripper 400 to engage the drill rod 610.

As shown in FIG. 6B, the process may include moving the alignment assembly 200 to the aligned state shown in FIG. 6B. The second gripper 400 may be actuated while the alignment assembly 200 is in the offset state shown in FIG. 6A or while the alignment assembly 200 is in the aligned state. While the alignment assembly 200 is in the aligned state, the casing 620 and the drill rod 610 are aligned with the drilling axis D-D.

With the drill rod 610 thus aligned and positioned, drill head 110A can be lowered to couple the connector 150A with the second end 610B of the drill rod 610. For example, drill head 110A can rotate the connector 150A into engagement with the second end 610B of the drill rod 610.

Thereafter, as shown in FIG. 6C, the second gripper 400 may be moved to an open state. As previously discussed, the second gripper 400 may be configured to open sufficiently to allow connector 150B to pass therethrough. As a result, drill head 110B may be lowered to couple connector 150B with the casing 620 while drill head 110A lowers the drill rod 610 into the casing 620. With the casing 620 and the drill rod 610 coupled to the drill heads 110B, 110A respectively, the first gripper 300 may be moved to its open state, the second gripper 400 may be moved to its open state, and the alignment assembly 200 may be moved to the offset state shown in FIG. 6A. Thereafter, the drill heads 110A, 110B may be lowered to couple the casing 620 and the drill rod 610 to a casing and drill rod that are engaged by the clamping/breaking assembly 160 as appropriate. The alignment process can then begin again, even while the drill heads 110A, 110B are placing the casing 620 and rill rod 620, since a portion of the process occurs at an offset location from the drilling axis D-D. Accordingly, the alignment assembly 200 may facilitate rapid alignment and coupling of threaded members to corresponding drill heads as well as relatively continuous drilling operations.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A gripper assembly, comprising:
a base arm defining a base axis;
a base extension coupled to said base arm, said base extension extending away from said base axis;
a first link member rotatingly coupled to said base arm;
a second link member rotatingly coupled to said first link member;
a first rotating gripper body rotatingly coupled to said second link member;
a third link member rotatingly coupled to said first link member; and
a second rotating gripper body rotatingly coupled to said third link member, wherein said first rotating gripper body, said second rotating gripper body, and said first base extension are rotatingly coupled by an axis pivot.

2. The gripper assembly of claim 1, further comprising an actuating mechanism coupled to said first link member.

3. The gripper assembly of claim 2, further comprising a second base extension coupled to said base arm, said second base extension extending away from said base axis in a same direction as said first base extension extends away from said base axis, said second base extension being further coupled to said actuating mechanism.

4. The gripper assembly of claim 3, wherein said gripper assembly includes a transverse axis, said transverse axis being transverse to and passing through said base axis, said axis pivot being positioned on a first side of the said transverse axis, wherein a first actuator pivot rotatingly couples said second base extension and said actuating mechanism, and wherein said first actuator pivot is positioned on a second side of said transverse axis, said second side being of said transverse axis being opposite said first side of said transverse axis.

5. The gripper assembly of claim 1, wherein a first link pivot rotatingly couples said first link member to said base arm, a second link pivot rotatingly couples said second link member to said first link member, and a third link pivot couples said third link member to said first link member; wherein said first link pivot, said second link pivot, and said third link pivot are non-collinear.

6. The gripper assembly of claim 1, wherein movement of an end of said first link member relative to said axis pivot moves a first jaw portion of said first rotating gripper body relative to a second jaw portion of said second rotating gripper body to change a diameter of an opening between said first jaw portion and said second jaw portion.

7. The gripper assembly of claim 6, wherein said movement of said end of said first link member moves said first jaw portion and said second jaw portion between a closed state and an open state, said opening having an closed diameter in said closed state and an open diameter in said open state, wherein said open diameter is greater than about five times said closed diameter.

8. A gripper assembly, comprising:
a shaft;
a first gripper rotatingly coupled to said shaft, said first gripper being configured to move between an open state and a closed state to selectively engage and release a first threaded member having a thread diameter; and
a second gripper rotatingly coupled to said shaft, said second gripper being configured to move between an open state and a closed state to selectively engage and release a second threaded member having an outer diameter, said threaded diameter being greater than said outer diameter.

9. The gripper assembly of claim 8, wherein when said second gripper is configured to allow a component having a diameter equal to or greater than said first outer diameter to pass therethrough when said second gripper is in said open state.

10. The gripper assembly of claim 8, further comprising a positioning mechanism configured to rotate said first gripper about said shaft.

11. The gripper assembly of claim 10, wherein said first gripper and said second gripper are configured to rotate together about said shaft.

12. An alignment assembly, comprising:
a shaft;
a first gripper coupled to said shaft, said first gripper including a fixed gripper body and a first rotating gripper body rotatingly coupled to said fixed gripper body; and
a second gripper coupled to the shaft, said second gripper including a second rotating gripper body, a third rotating gripper body, and an axis pivot rotatingly coupling said second rotating gripper body and said third rotating gripper body.

13. The alignment assembly of claim 12, wherein said shaft includes a shaft axis, said shaft being configured to be mounted to a drill mast to position said shaft axis parallel to a drilling axis of the drill mast.

14. The assembly of claim 13, wherein a gripping axis is defined between a center of a first gripper opening and a center of a second gripper opening, said first gripper opening being defined between said fixed gripper body and said first rotating gripper body when said first gripper is in a closed state, wherein said second gripper opening is defined between said second rotating gripper body and said third rotating gripper body when said second gripper is in a closed state.

16. The assembly of claim 14, wherein the alignment assembly further includes a positioning mechanism configured to move said alignment assembly between an aligned state and an offset state, wherein when said alignment assembly is in said aligned state said gripping axis is aligned with the drilling axis.

15. The assembly of claim 13, wherein said first gripper is configured to engage an outer threaded member, said first gripper being further configured to move the outer threaded member to an orientation that is parallel to said shaft axis when said first gripper engages the outer threaded member.

16. The assembly of claim 12, wherein said second gripper includes a base arm defining a base axis, a first base extension coupled to said base arm, said first base extension extending away from said base axis, a first link member rotatingly coupled to said base arm, a second link member rotatingly coupled to said second rotating gripper body, a third link member rotatingly coupled to said first link member, said third link member being further rotatingly coupled to said third rotating gripper body, and an axis pivot rotatingly coupling said second rotating gripper body, said third rotating gripper body, and said first base extension.

17. The assembly of claim 12, further comprising a support assembly configured to be coupled to the drill mast.

18. The assembly of claim 17, wherein said support assembly includes a mounting assembly configured to be mounted the drill mast, a swing frame rotatingly coupled to said mounting assembly, a slide frame coupled to said swing frame, and a slide slidingly coupled to said slide frame, wherein said slide is configured to translate transverse to said shaft axis.

19. A drilling system, comprising:
a mast;
a first connector being configured to engage an inner threaded member;
a second connector being configured to engage an outer threaded member; and
an alignment assembly, comprising:
a first gripper coupled to said shaft, said first gripper including a fixed gripper body and a first rotating gripper body rotatingly coupled to said fixed gripper body; and
a second gripper coupled to said shaft, said second gripper including a second rotating gripper body and a third rotating gripper body, and an axis pivot rotatingly coupling said second rotating gripper body and said third rotating gripper body, said second gripper being configured to move between an open state and a closed state, wherein when said second gripper is in said open state an opening is defined between said second rotating gripper body and said third rotating gripper body, said opening having a diameter larger than a diameter of said second connector.

20. The drilling system of claim 19, wherein said second gripper includes a base arm defining a base axis, a first base extension coupled to said base arm, said first base extension extending away from said base axis, a first link member rotatingly coupled to said base arm, a second link member rotatingly coupled to said second rotating gripper body, a third link member rotatingly coupled to said first link member, said third link member being further rotatingly coupled to said third rotating gripper body, and an axis pivot rotatingly coupling said second rotating gripper body, said third rotating gripper body, and said first base extension.

21. The drilling system of claim 19, wherein said first connector is positioned at least partially within said second connector.

22. The drilling system of claim 19, further comprising a rotary head configured to rotate said first connect and said second connector.

23. The drilling system of claim 19, further comprising a first rotary head coupled to said first connector and a second rotary head coupled to said second connector.
